(19) United States
(12) Patent Application Publication
(10) Pub. No.: US 2018/0127125 A1
(43) Pub. Date: May 10, 2018

(54) OVEN CANNING METHOD

(71) Applicant: Tyler John Lee, Livermore, CA (US)

(72) Inventor: Tyler John Lee, Livermore, CA (US)

(21) Appl. No.: 15/345,998

(22) Filed: Nov. 8, 2016

(51) Int. Cl. B65B 25/00; A23L 3/10; B65B 63/08; B65D 85/00; B65B 7/28; B65B 39/00

(52) U.S. Cl. CPC B65B 25/001; A23L 3/10; B65B 63/08; A23V 2002/00; B65B 7/28; B65B 39/007; B65D 85/70

(57) ABSTRACT

A method for reducing and canning a food product through oven canning may include overfilling a canning container with a food product; and heating the canning container to reduce the food product into a reduced food product, wherein the volume of the food product to be reduced is larger than a volume of the canning container. Overfilling the canning container may be achieved by inserting a funnel into the canning container and filling both the canning container and at least a portion of the funnel with the food product to be reduced.

### BACKGROUND

The embodiments herein relate generally to canning, and more particularly, to an oven canning method including overfilling the canning containers.

High moisture foods spoil in a short time frame. Canning is conventionally used to preserve such foods. However, previous methods for thermally processing canned foods in an oven have failed to achieve acceptable sanitary conditions for food preservation. Specifically, in lid-on methods, mechanical failure results in cracking jars, the lid gasket becoming brittle and not sealing well, and the formation of cold spots that leads to microbial spoilage. Lid-off methods evaporate the product producing a large head space or require refilling the jar after the thermal process, risking recontamination.

Therefore, what is needed is of a lid off oven canning method that removes the need to refill the canning container and maintains sanitary conditions.

### SUMMARY

Some embodiments of the present disclosure include a canning method. The method for reducing and canning a food product through oven canning may include overfilling a canning container with a food product; and heating the canning container to reduce the food product into a reduced food product, wherein the volume of the food product to be reduced is larger than a volume of the canning container. Overfilling the canning container may be achieved by inserting a funnel into the canning container and filling both the canning container and at least a portion of the funnel with the food product to be reduced.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure.

FIG. 2 is a section view of one embodiment of the present disclosure.

FIG. 3 is a section view of one embodiment of the present disclosure.

FIG. 4 is a flowchart describing one embodiment of the present disclosure.

FIG. 5 is a continuation of FIG. 4.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The method of the present disclosure may be used to reduce and preserve a food product through oven canning and may comprise the following elements. This list of possible constituent elements is intended to be exemplary only, and it is not intended that this list be used to limit the method of the present application to just these elements. Persons having ordinary skill in the art relevant to the present disclosure may understand there to be equivalent elements that may be substituted within the present disclosure without changing the essential function or operation of the method.

1. Canning Container

2. Funnel

The various elements of the method of the present disclosure may be related in the following exemplary fashion. It is not intended to limit the scope or nature of the relationships between the various elements and the following examples are presented as illustrative examples only.

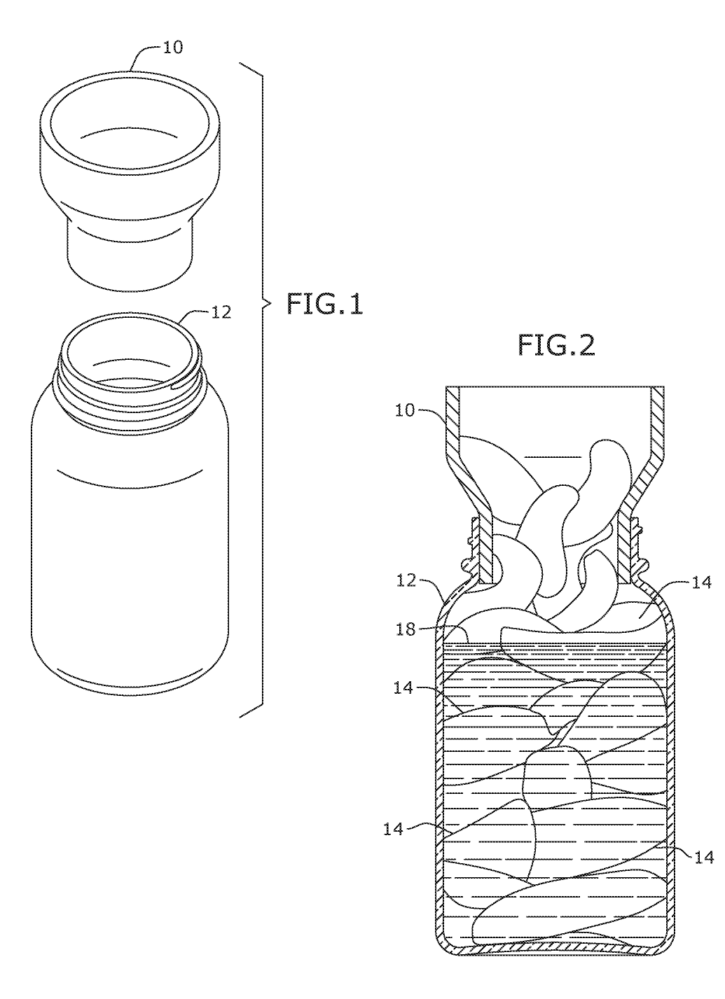

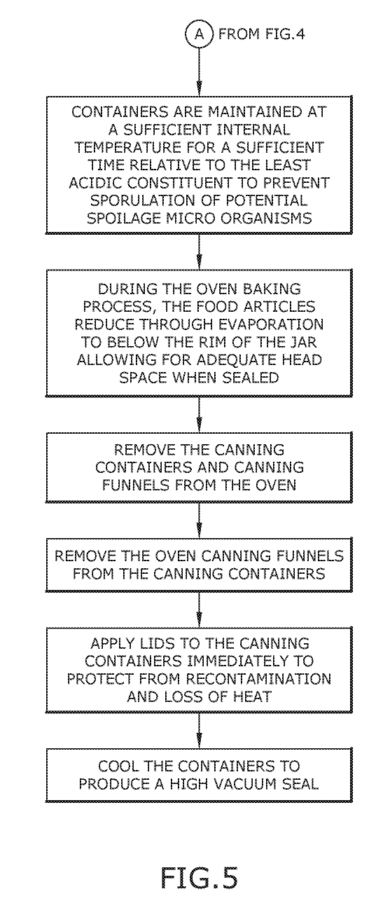

By way of example, and referring to FIGS. 1-5, some embodiments of the present disclosure include a method for reducing and canning a food product through oven canning, the method comprising: overfilling a canning container 12 with a food product 14; and heating the canning container 12 in, for example, an oven to reduce the food product 14 into a reduced food product 16, wherein because the canning container 12 was overfilled, the canning container 12 does not need to be topped off with additional reduced food product 16 after heating, and the volume of the food product 14 to be reduced is larger than a volume of the canning container 12. Overfilling the canning container 12 may comprise inserting a funnel 10 into a mouth of the canning container 12 and filling both the canning container 12 and the funnel 10 with the food product 14. The canning container 12 and the funnel 10 may together be subjected to heating.

The method of the present disclosure may further comprise removing the funnel 10 from the canning container 12 after heating and reducing is completed and applying a lid to the canning container 12. The container 12 with the lid may be cooled, producing a high vacuum therein due to the condensation of steam within the container 12.

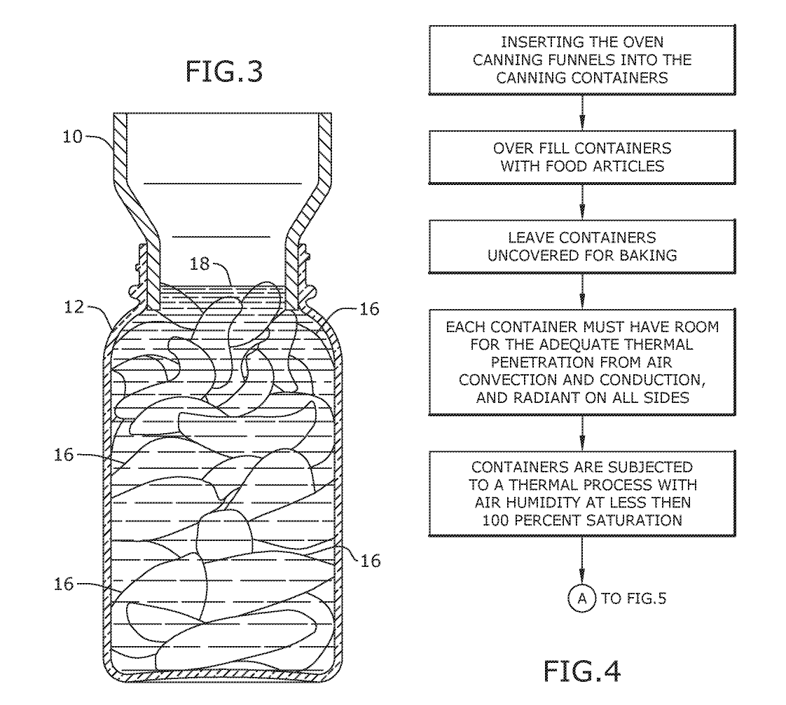

As shown in FIGS. 1-3, the canning container 12 of the present disclosure may be any suitable or conventional canning container, such as a mason jar. The funnel 10 may comprise a narrowed stem and a larger mouth, wherein the stem extends downward from the bottom portion of the mouth. Thus, the funnel 10 may be similar in structure to conventional funnels. The stem of the funnel 10 may have a diameter slightly smaller than an inner diameter of the opening of the canning container 12, such that the stem of the funnel 10 fits within the opening of the canning container, as shown in FIGS. 2 and 3. The funnel 10 may be made of any suitable oven-safe material.

As shown in FIG. 2, the canning container 12 may be overfilled such that the food product 14 fills the inner volume of the canning container 12 and at least a portion of the funnel 10. Any combination of ingredients, including a liquid 18, such as water, may be added to the canning container 12 for reducing purposes.

As shown in FIG. 3, once the canning container 12 and the funnel 10 have been heated and the food product 14 has been reduced, the reduced food product 16 may substantially fill the canning container 12. Thus, the method of the present disclosure may not require refilling, topping off, or otherwise reducing headspace in the canning container 12.

The method of the present disclosure may thus comprise, in more detail, inserting the funnel 10 into the canning container 12; overfilling the canning container 12 by filling food product 14 in the entire volume of the canning container 12 and at least a portion of the funnel 10; leaving the canning container 12 and the funnel 10 uncovered for baking; arranging multiple canning containers 12 in the oven (or other thermal heater), wherein each canning container 12 has an adequate open space surrounding the canning container 12 for adequate thermal penetration from air convection and conduction and oven radiation; subjecting the canning containers 12 to a thermal process with air humidity at less than 100% saturation; maintaining a sufficient internal temperature in the canning containers 12 for a sufficient amount of time relative to the least acidic constituent to prevent sporulation of potential spoilage microorganisms, wherein the food product 14 reduces through evaporation to below the rim of the canning container 12, allowing for adequate headspace when filled; removing the canning container 12 and funnel 10 from the oven; removing the funnel 10 from the canning container 12; applying a lid to the canning container 12 to protect from recontamination and loss of heat; and cooling the containers to produce a high vacuum seal.

In embodiments, the canning container 12 combined with the funnel 10 may be filled to exceed the capacity of the canning container 12 from 100% to 500%. However, the exact percentage overfilled may depend on the food product 14 being reduced and the final desired quality.

When arranged for heating, each of the canning containers 12 may have an area of at least about 0.1 inches surrounding the canning container 12 that is open. However, the exact space may depend on the convective design of the oven.

The canning containers 12 may be heated to a temperature of from about 140F to about 500° F. at an air humidity level of from about 0% to about 99.9%, wherein the canning containers 12 may maintain an internal temperature of from about 140 to about 250° F. The canning containers 12 may be heated for a time period of from about 10 minutes to about 6 hours. After the funnel 10 is removed and the lid is applied, the canning containers 12 may be cooled to room temperature, or about 70° F. However, as is well understood, the process configuration of time, temperature, and humidity may vary depending on the end quality desired of a food product 14 being reduced.

An exemplary method of the present disclosure may be demonstrated in the canning of peaches. Desirable results have been observed through a processing configuration as follows. Peaches are placed in an 8 oz canning container with funnel to the specific weight of 260 g or 115% exceeding the capacity of the container. A moisture reduction of 15% has been observed over a 120 -minute thermal process with the oven configured at 300F and the air convection set on high. The resulting product reduces into the jar to fill 100% of its capacity. With a 15% moisture reduction in the peaches tested, the sugar concentration of the peach juice surrounding the peaches is favorably increased from 19 brix to 25 brix while optimizing the Maillard reactions associated with developing a peach cobbler aroma. To target a higher moisture reduction favorable results have been observed by processing horizontally for better convective contact.

The method of the present disclosure solves problems associated with conventional lid-off methods by eliminating the need for refilling or reducing a large headspace. Specifically, headspace may be controlled by overfilling and by covering during bake.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A method for reducing and canning a food product through oven canning, the method comprising:
overfilling a canning container with a food product; and
heating the canning container to reduce the food product into a reduced food product, wherein:
the volume of the food product to be reduced is larger than a volume of the canning container.

2. The method of claim 1, wherein:
overfilling the canning container comprises inserting a funnel into a mouth of the canning container and filling both the canning container and at least a portion of the funnel with the food product to be reduced; and
the canning container and the funnel are both subjected to heating.

3. The method of claim 1, wherein the canning container is subjected to heating without a lid covering the canning container.

4. The method of claim 1, wherein the canning container is heated to a temperature of from about 140° F. to about 500° F.

5. The method of claim 4, wherein the canning container is heated for a time period of from about 10 min to about 6 hours.

6. The method of claim 1, wherein an air humidity level during the heating is less than 100%.

7. A method for reducing and canning a food product through oven canning, the method comprising:
inserting a funnel into a mouth of a canning container;
overfilling the canning container by adding enough food product to fill an entire internal volume of the canning container and at least a portion the funnel;
leaving the canning container and the funnel uncovered for baking;
subjecting the canning container and the funnel to a thermal process with air humidity at less than 100% saturation;
removing the canning container and the funnel from the oven;
removing the funnel from the canning container;
applying a lid to the canning container to protect from recontamination and loss of heat; and
cooling the canning containers to produce a vacuum seal.

8. The method of claim method of claim 7, wherein the canning container is heated to a temperature of from about 140° F. to about 500° F.

9. The method of claim 8, wherein the canning container is heated for a time period of from about 10 minutes to about 6 hours.
